(19) United States
(12) Patent Application Publication
(10) Pub. No.: US 2016/0371656 A1
(43) Pub. Date: Dec. 22, 2016

(54) METHOD, SYSTEM, AND NON-TRANSITORY COMPUTER-READABLE MEDIUM FOR MEETING PLACE RECOMMENDATION USING APPOINTMENT INFORMATION

(71) Applicant: LINE Corporation, Tokyo (JP)

(72) Inventors: Hyuk Hur, Seongnam-si (KR); Won Joon Choi, Seongnam-si (KR)

(73) Assignee: LINE Corporation, Tokyo (JP)

(21) Appl. No.: 15/184,066

(22) Filed: Jun. 16, 2016

(30) Foreign Application Priority Data
Jun. 17, 2015 (KR) 10-2015-0085582

(51) Int. Cl. G06Q 10/10; G06Q 10/02; H04L 12/58

(52) U.S. Cl. CPC G06Q 10/1095; H04L 51/32; H04L 51/36; G06Q 10/02

(57) ABSTRACT

Provided are a method, system, and non-transitory computer-readable medium for recommending a meeting place based on appointment information. The meeting placement recommendation method may include enrolling appointment information based on information received from a user terminal over a network; selecting affiliated stores based on location information including the enrolled appointment information; providing the appointment information to the selected affiliated stores, and providing an enrollment function of enrolling a counter offer associated with the appointment information to the affiliated stores, the enrollment function including a function that enables the affiliated stores to input and enroll recommendation information about at least one of a place, a product, and a service in association with the appointment information; and providing the recommendation information enrolled through the function to the user terminal.

### CROSS-REFERENCE TO RELATED APPLICATION

This application claims the benefit of priority under 35 U.S.C. §119 to Korean Patent Application No. 10-2015-0085582 filed Jun. 17, 2015, in the Korean Intellectual Property Office (KIPO), the entire contents of which are incorporated herein by reference.

### BACKGROUND

Field

One or more example embodiments relate to technology for recommending a meeting place based on appointment information.

Description of Related Art

Recently, with the development in mobile and ubiquitous infrastructures, a variety of user customized services have evolved.

A customized service according to the related art provides peripheral products or information based on location information or preference information of a user.

An existing location-based place search service is generally at a simple, or rudimentary level, such as providing a search result related to a user's location, or providing supporting category browsing based on an area of a corresponding location, and the like.

### SUMMARY

One or more example embodiments provide a meeting place recommendation methods, systems, and non-transitory computer-readable media that may provide appointment information of a meeting associated with users to affiliated stores, may receive recommendation information about a meeting place from the affiliated stores, and may provide the received recommendation information to the users.

At least one example embodiment provides a method executed by at least one processor, the method including enrolling, using at least one processor, appointment information based on information received from at least one user terminal over a network; selecting, using the at least one processor, at least one affiliated store from a plurality of affiliated stores based on location information, the location information including the enrolled appointment information; transmitting, using the at least one processor, the appointment information to the selected at least one affiliated store over the network, and enrolling at least one counter offer associated with the appointment information from at least one of the plurality of affiliated stores, the enrollment including enabling the plurality of affiliated stores to input and enroll recommendation information about at least one of a place, a product, and a service in association with the appointment information; and transmitting, using the at least one processor, the enrolled recommendation information to the at least one user terminal.

The method may further include transmitting, using the at least one processor, a reservation request for a meeting place to an affiliated store having enrolled the recommendation information in response to a request from the user terminal.

The transmitting of the recommendation information may include transmitting a list of affiliated stores having enrolled the recommendation information to the user terminal. The method may further include receiving, using the at least one processor, a selection on a desired affiliated store from the list of affiliated stores from the user terminal; and transmitting, using the at least one processor, a reservation request for a meeting place to the desired affiliated store in response to receiving the selection.

The method may further include receiving, using the at least one processor, a selection on a plurality of affiliated stores from the list of affiliated stores from the user terminal; enrolling, using the at least one processor, a vote for the plurality of affiliated stores based on the appointment information in response to receiving the selection on the plurality of affiliated stores; receiving, using the at least one processor, a vote intention for one of the plurality of affiliated stores from a terminal of each of persons associated with the appointment information; and selecting, using the at least one processor, the desired affiliated store from among the plurality of affiliated stores based on the vote intention.

The transmitting of the recommendation information may include transmitting a corresponding affiliated store within a messenger application with respect to each of the affiliated stores included in the list of affiliated stores.

The method may further include transmitting, using the at least one processor, reservation information to at least one terminal of each of persons associated with the appointment information if a reservation for the meeting place is completed.

The method may further include transmitting, using the at least one processor, an alert of the appointment information to at least one terminal of each of persons associated with the appointment information based on time information included in the enrolled appointment information.

The enrolling may include enrolling appointment information created through a messenger application.

The enrolling may include managing a reservation status of an affiliated store in association with a messenger application.

The enrolling may include updating the appointment information based on attendance or absence of each of persons associated with the appointment information.

At least one example embodiment also provides a non-transitory computer-readable medium including computer readable instructions which when executed by at least one processor, causes the at least one processor to enroll appointment information based on information received from at least one user terminal over a network; select affiliated stores based on location information including the enrolled appointment information; transmit the appointment information to the selected affiliated stores, and enrolling a counter offer associated with the appointment information to the affiliated stores, the enrolling including enabling the affiliated stores to input and enroll recommendation information about at least one of a place, a product, and a service in association with the appointment information; and transmit the recommendation information enrolled through the user terminal.

At least one example embodiment also provides a system for recommending a meeting place, the system including a memory having computer readable instructions stored thereon; and at least one processor configured to execute the computer readable instructions to, enroll appointment information based on information received from at least one user terminal over a network, select affiliated stores based on location information including the enrolled appointment information, and transmit the appointment information to the selected affiliated stores, and enrolling a counter offer associated with the appointment information to the affiliated stores and transmit the enrolled recommendation information to the at least one user terminal, the enrolling including enabling the affiliated stores to input and enroll recommendation information about at least one of a place, a product, and a service in association with the appointment information.

The at least one processor may be further configured to transmit a reservation request for a meeting place to an affiliated store having enrolled the recommendation information in response to a request from the at least one user terminal.

The at least one processor may be further configured to transmit a list of affiliated stores having enrolled the recommendation information to the at least one user terminal; and transmit a reservation request for a meeting place to a desired affiliated store in response to receiving a selection on the desired affiliated store from the list of affiliated stores from the at least one user terminal.

In response to receiving a selection on a plurality of affiliated stores from the list of affiliated stores from the at least one user terminal, the at least one processor may be further configured to enroll a vote for the plurality of affiliated stores based on the appointment information, receive a vote intention for one of the plurality of affiliated stores from at least one terminal of each of persons associated with the appointment information, and select the desired affiliated store from among the plurality of affiliated stores based on the vote intention.

The at least one processor may be further configured to transmit to a corresponding affiliated store within a messenger application with respect to each of the affiliated stores included in the list of affiliated stores.

The at least one processor may be further configured to transmit reservation information to at least one terminal of each of persons associated with the appointment information if a reservation for the meeting place is completed.

The at least one processor may be further configured to transmit an alert of the appointment information to at least one terminal of each of persons associated with the appointment information based on time information included in the enrolled appointment information.

The at least one processor may be further configured to enroll appointment information created through a messenger application.

The enrolling may include managing a reservation status of an affiliated store in association with a messenger application.

According to at least some example embodiments, it is possible to effectively connect a purchase and a service between a user and an affiliated store by providing appointment information of a meeting associated with users to affiliated stores, and by receiving recommendation information about a meeting place from the affiliated stores as a counter offer and providing the received recommendation information to the users.

Also, according to at least some example embodiments, it is possible to reduce, or alternatively, minimize inconvenience and cumbersomeness of users taken to find a meeting place by running through appointment information. Further, since users may immediately proceed with a reservation procedure in response to a counter offer from an affiliated store, the users may further easily and conveniently determine the meeting place.

Also, according to at least some example embodiments, an affiliated store may achieve shop/store promotion and customer attraction through an online to offline (O2O) marketing opportunity by providing recommendation information with respect to appointment information of users.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIGS. 1 and 2 are diagrams illustrating an example of a meeting place recommendation environment according to at least one example embodiment;

FIG. 3 is a block diagram illustrating a configuration of a meeting place recommendation system according to at least one example embodiment;

FIG. 4 is a flowchart illustrating a meeting place recommendation method according to at least one example embodiment;

FIG. 5 illustrates an example of a user interface screen associated with an appointment enrollment procedure according to at least one example embodiment;

FIGS. 6 through 8 illustrate examples of a user interface screen associated with a counter offer enrollment procedure of an affiliated store according to at least one example embodiment;

FIGS. 9 through 12 illustrate examples of a user interface screen associated with a place recommendation procedure according to at least one example embodiment; and

FIG. 13 is a block diagram illustrating an example of a computer system according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such “as at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Example embodiments relate to technologies for recommending a meeting place based on various information, including appointment information of at least one user. In detail, various example embodiments relate to methods, systems, and non-transitory computer-readable media that may provide information, including appointment information of a meeting associated with one or more users to affiliated stores, may receive recommendation information about a meeting place from the affiliated stores, and may provide the received recommendation information to the one or more users.

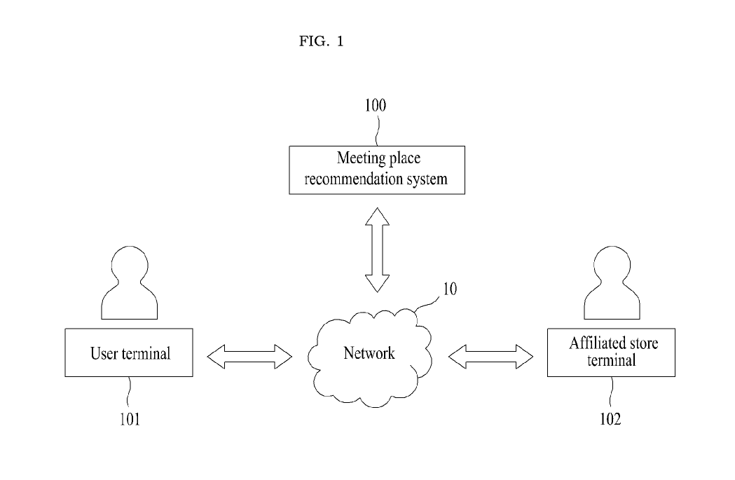

FIG. 1 is a diagram illustrating an example of a meeting place recommendation environment according to at least one example embodiment. FIG. 1 illustrates a user terminal 101, an affiliated store terminal 102, a meeting place recommendation system 100. In FIG. 1, indicators with arrowheads may indicate that data may be transmitted and received between constituent elements over a wired and/or wireless network 10.

The user terminal 101 and the affiliated store terminal 102 may execute computer readable instructions related to one or more processes that, when executed by at least one processor installed on the user terminal 101 and/or the affiliated store terminal 102, transform the at least one processor of the user terminal 101 and/or the affiliated store terminal 102 into a special purpose processor configured to perform at least one of the features described herein. The user terminal 101 and the affiliated store terminal 102 may refer to any type of computer processing devices or mobile devices capable of connecting to a website and/or mobile site associated with the meeting place recommendation system 100 and/or installing and executing a service exclusive application (hereinafter, a service app). In this example, the user terminal 101 and the affiliated store terminal 102 may perform the overall service operation, such as service screen configuration, data input, data transmission and/or reception, data storage, and the like, under control of the website/mobile side and/or the service app.

The user terminal 101 and the affiliated store terminal 102 may include a personal computer (PC), a notebook computer, a laptop computer, a smartphone, a tablet, a wearable computer, a gaming console, a personal digital assistant (PDA), a virtual reality (VR) device, an augmented reality (AR) device, an Internet of Things (IoT) device, etc. The devices listed are only examples, and the example embodiments are not limited thereto.

The user terminal 101 and the affiliated store terminal 102 may be directly or indirectly coupled to the network 10, for example, the Internet, an intranet, a wide area network, a local area network, a personal area network, etc. For example, a PC and a notebook computer may be directly connected to the network 10 through a wired network connection. A laptop computer may be wirelessly connected to the network 10 through a wireless communication channel formed between the laptop computer and a wireless access point (WAP). A smartphone may be wirelessly connected to the network 10 through a wireless communication channel formed between the smartphone and a cellular network/bridge. In this example, the network 10 may communicate with one or more secondary networks (not shown), for example, a local area network (LAN), a wide area network (WAN), intranet, etc. It is only an example and thus, the example embodiments are not limited thereto.

The user terminal 101 and the affiliated store terminal 102 may mutually, or individually, interface with the meeting place recommendation system 100 over the network 10.

The meeting place recommendation system 100 may execute one or more processes configured to perform at least one of the features described herein. In particular, the meeting place recommendation system 100 serves to connect information between the user terminal 101 and the affiliated store terminal 102, and may provide a meeting place recommendation service and/or other services that provide counter offers of affiliated stores with respect to a meeting of a user.

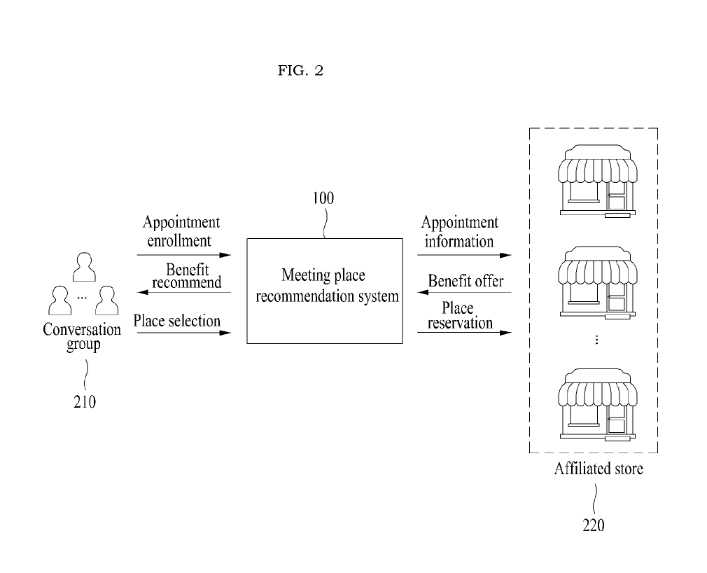

Hereinafter, an example scenario of a meeting place recommendation service is described with reference to FIG. 2 according to at least one example embodiment.

First, a user enrolls appointment information about a meeting through a calendar function, a scheduling function, an email function, a personal organization function, etc., to share with other users included in a desired user group 210 of a messenger application, a social media application, an email application, a calendar application, a personal organization application, a gaming application, etc. (hereinafter collectively referred to as “messenger application” for the sake of brevity). The messenger application is executed on a user terminal, such as the user terminal 101 of FIG. 1.

Second, the meeting place recommendation system 100 transmits and/or transfers, to affiliated stores, service providers, other users, and the like (hereinafter collectively referred to as “affiliated stores” for the sake of brevity) 220, appointment information enrolled on the messenger application regarding the meeting of the user.

Third, the affiliated stores 220 verify the appointment information of the user and transmit available benefits to the meeting place recommendation system 100 over the network 10.

Fourth, the meeting place recommendation system 100 recommends (or, selectively recommends) the benefits offered by the affiliated stores 220 to the user through the user group 210 over the network 10.

Fifth, the user verifies the benefits offered by the affiliated stores and selects a desired affiliated store as a meeting place by indicating the user's selection through a user interface of the messenger application.

Sixth, the meeting place recommendation system 100 transmits a request for the selected desired affiliated store for a reservation as the meeting place for the meeting of the user.

The meeting place recommendation system 100 may be one or more server computers, for example, a server computing device, a PC, a server computer, a series of connected server computers (e.g., distributed servers), a mini computer, a main computer, etc. However, this list is only provided as an example and the example embodiments are not limited thereto. The server computer may be a distributed system and operations of the server computer may be concurrently and/or sequentially executed on one or more processors and/or processor cores included in the server computer(s).

The meeting place recommendation system 100 may be included in a platform of a messenger server or other application server (not shown) that provides a messenger service or other application service, and without being limited thereto, may be configured as a system separate from the server (e.g., messenger server) to provide a meeting place recommendation service through interaction with the server (e.g., messenger server). At least a portion of constituent elements of the meeting place recommendation system 100 may be configured as an application form installed on the user terminal 101 and/or the affiliated store terminal 102, or may be included in a platform that provides a service in a client-server environment, but is not limited thereto.

A meeting place recommendation system and a meeting place recommendation method according to at least some example embodiments will be described.

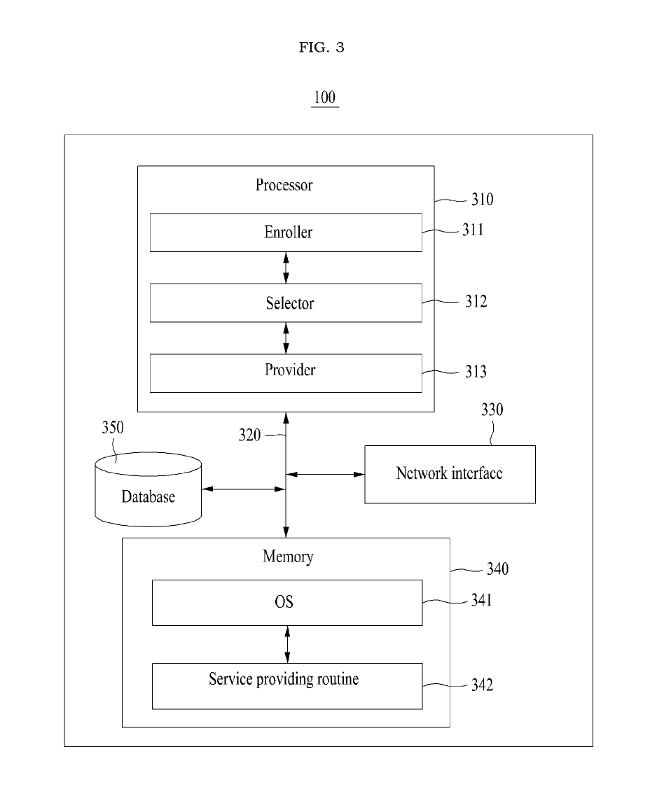

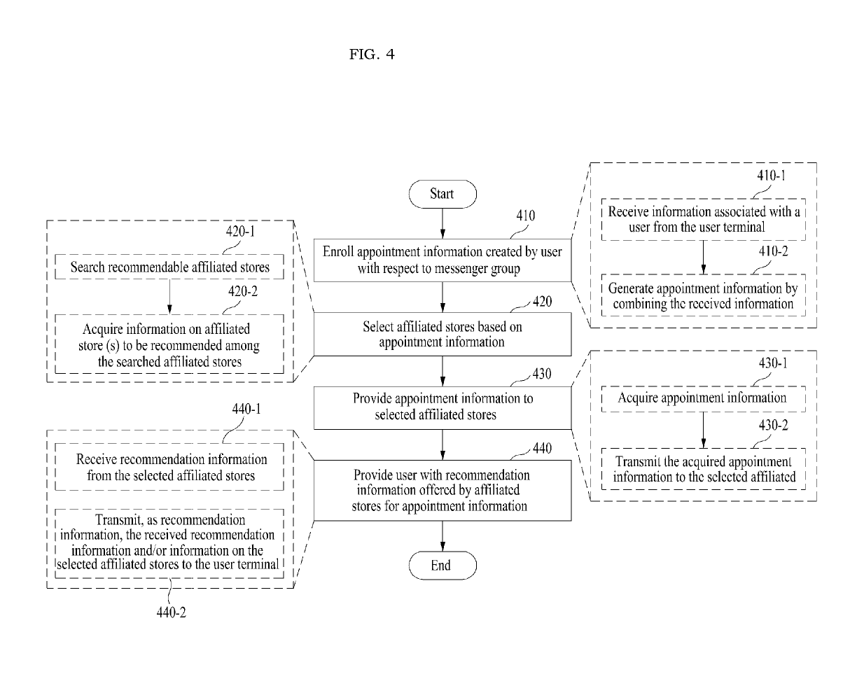

FIG. 1 is a diagram illustrating an example of a meeting place recommendation environment according to at least one example embodiment. FIG. 3 is a block diagram illustrating a configuration of a meeting place recommendation system according to at least one example embodiment, and FIG. 4 is a flowchart illustrating a meeting place recommendation method according to at least one example embodiment.

Referring to FIG. 3, a meeting place recommendation system 100 includes at least one processor 310; a bus 320; a network interface 330; a memory 340; and a database 350. In this example, the memory 340 includes an operating system (OS) 341 and/or a service providing routine 342. The processor 310 may include an enroller 311, a selector 312, and/or a provider 313. According to at least some other example embodiments, the meeting place recommendation system 100 may include a greater or lesser number of constituent elements than the number of constituent elements shown in FIG. 3. H For example, the meeting place recommendation system 100 may include other constituent elements such as a display, a transceiver, etc.

The memory 340 may include a permanent mass storage device, such as random access memory (RAM), read only memory (ROM), a disk drive, a solid state drive, a network drive, etc., as a non-transitory computer-readable storage medium. Also, program code or codes (e.g., computer-readable instructions) for the OS 341 and the service providing routine 342 may be stored in the memory 340. Additionally, computer readable instructions related to the enroller 311, selector 312, and/or provider 313 may be stored in the memory 340 before being loaded onto the at least one processor 310, thereby transforming the processor 310 into a special purpose processor. Moreover, the processor 310 may be preconfigured to execute the enroller 311, selector 312, and/or provider 313. The software constituent elements may be loaded from another non-transitory computer-readable storage medium separate from the memory 340 using a drive mechanism (not shown). The other non-transitory computer-readable storage medium may include, for example, a floppy drive, a disc, a tape, a Blu-ray/DVD/CD-ROM drive, a memory card, etc. Software constituent elements may be loaded to the memory 340 through the network interface 330 instead of, or in addition to, the non-transitory computer-readable storage medium.

The bus 320 enables communication and data transmission between the constituent elements of the meeting place recommendation system 100. The bus 320 may be configured using a high-speed serial bus, a parallel bus, a storage area network (SAN), and/or another appropriate communication technology.

The network interface 330 may be a computer hardware constituent element for connecting the meeting place recommendation system 100 to a computer network. The network interface 330 may be a network interface card (NIC), such as an Ethernet card, an optical transceiver, a wireless frequency transceiver, a combination thereof, or a different type of device capable of transmitting and receiving information. Other examples of the network interface 330 may be a wireless device including mobile computing devices, Bluetooth within a universal serial bus (USB), 3rd generation (3G), 4th generation (4G), 5th generation (5G), wireless fidelity (WiFi), and the like. In at least some example embodiments, the information sharing system 300 may use the network interface 330 to wirelessly communicate with an external device, such as a server, a mobile phone, a network computing device, and the like. The network interface 330 may connect the meeting place recommendation system 100 to a computer network through a wireless and/or wired connection.

The database 350 may serve to store and maintain information required to provide a meeting place recommendation service. The database 350 may store appointment information for each user. In this example, the appointment information is meeting related information created through a calendar function, a schedule function, etc., on a platform, for example, a messenger platform, a social media platform, an email platform, a calendar platform, a personal organization platform, a gaming platform, etc., and may include a place, a time, a number of attendees, individual user information, for example, a messenger account, financial account information (e.g., bank account, credit card account, etc.), demographic information of the user (e.g., age, sex, occupation, salary information, etc.), contact information (e.g., phone number, email address, mailing address, etc.), user preferences (e.g., favorite affiliated stores, favorite meeting places, favorite activities, favorite meeting times, etc.), appointment history information, meeting place history information, etc., of each of the attendees. The database 350 may store affiliated store information for each affiliated store. In this example, the affiliated store information may include business type information, product/service information, a telephone number, location information, scale information, price information, and the like. The affiliated store information may be used as information to select an affiliated store based on the appointment information.

Although FIG. 3 illustrates that the database 350 is included as part of the meeting place recommendation system 100, it is only an example. The database 350 may be omitted based on a system configuration method and/or environment, etc. Additionally, all of or a portion of the database 350 may be desired and/or preset as an external database configured on a separate system.

Still referring to FIG. 3, the processor 310 may be configured to process computer-readable instructions of a computer program by performing basic arithmetic operations, logic operations, and/or input/output operations of the meeting place recommendation system 100. The computer-readable instructions may be provided from the memory 340 and/or the network interface 330 to the processor 310 through the bus 320. The processor 310 may be configured to execute a program code to cause the processor 310 to perform functions described herein with regard to the enroller 311, the selector 312, and the provider 313. The program code may be stored in a storage device, such as the memory 340.

The enroller 311, the selector 312, and the provider 313 may be configured to perform operations 410 through 440 of FIG. 4 according to at least one example embodiment.

Referring to FIG. 4, in operation 410, the enroller 311 may enroll appointment information associated with a user based on information received from a user terminal of the user. For example, the enroller 311 may enroll appointment information created through a calendar function, a schedule function, etc., of a messenger or other application installed in the user terminal in association with the user. In this example, the appointment information may include a place (location) of a meeting, a time, the duration of the appointment, the number of persons, the identity of the persons, activities enjoyed by the persons, etc. The number of persons associated with the meeting may include one or more conversation parties selected by the user from among conversion parties registered to the messenger as a conversation group of the messenger, or may include individuals who are not registered to the messenger and/or a part of the conversation group who are identified using other contact information, such as an email address, telephone number, SMS number, etc. The enroller 311 may update corresponding appointment information if each of the users included in the persons for the enrolled appointment information sets whether to attend the meeting. The number of persons associated with the meeting may be classified into an attendee having expressed intention to attend the meeting and an absentee having expressed intention not to attend the meeting.

The enrollment of the appointment information may be performed, e.g., by operations 410-1 and 410-2 as follows. In operation 410-1, the enroller 311 may receive information associated with the user from the user terminal. For example, the enroller 311 may receive the information input via a calender function or schedule management function associated with the messenger application installed in the user terminal. In operation 410-2, the enroller 311 may generate appointment information by combining the received information. The generated appointment information may be enrolled and stored in the database 350 and/or another external database.

In operation 420, the selector 312 may select affiliated stores recommendable as a meeting place based on the appointment information enrolled in operation 410. The selector 312 may select affiliated stores based on a place (location), a time, the number of persons, user/attendee preferences, etc., included in the appointment information. For example, the selector 312 may select affiliated stores around a corresponding location, for example, affiliated stores within a desired and/or preset radius, or affiliated stores associated with the location based on location information included in appointment information. An affiliated store selection criterion is not limited to the location of the meeting. An affiliated store may be selected by applying a variety of other criteria and/or applying a plurality of criteria.

The selection of the affiliated stores may be performed, e.g., by operations 420-1 and 420-2 as follows. In operation 420-1, the selector 312 may search the database 350 or another external database for the recommendable affiliated stores using the predetermined criterion. In operation 420-2, the selector 312 may select affiliated store (s) to be recommended, i.e., the selected affiliated stores, among the searched affiliated stores and acquire information on the selected affiliated stores. The acquired information may include at least one of the name of the selected affiliated store, the location thereof, and the telephone number thereof.

In operation 430, the provider 313 may provide the appointment information and/or other information related to the user and the other attendees to the affiliated stores selected based on the appointment information. In this instance, the provider 313 may provide an enrollment function that enables one or more of the affiliated stores to enroll a counter offer (e.g., a response to the user's appointment information) associated with the appointment information. In other words, the user's appointment information may be regarded as an initial offer providing initial terms of a reservation of a meeting place by providing the criteria desired for the meeting place (e.g., location, time of day, duration, number of attendees, cost, services offered at the location, etc.) and the counter offer may be a selected affiliated stores acceptance of the initial offer provided by the user and/or attendees, or a counter offer offering modified terms/criteria for the appointment (e.g., different location, different time of day, different duration, different number of attendees, different cost, special offers—such as sales offers for products/services offered at the location, etc.). The enrollment function includes a function that enables the affiliated stores to verify the appointment information with the user and/or attendees in response to displaying the appointment information, a function that enables the affiliated stores to input and enroll recommendation information about at least one of a place, a product, a service, and the like. The enrollment function may further include a reservation management function capable of managing a reservation status and processing a reservation by proxy in association with a calendar, a schedule, etc., on a platform. The provision of the appointment information may be performed, e.g., by operations 430-1 and 430-2 as follows. In operation 430-1, the provider 313 may acquire appointment information from the database 350 or another external database. In operation 430-2, the provider 313 may transmit the acquired appointment information to the selected affiliated stores.

In operation 440, the provider 313 may provide recommendation information enrolled by the affiliated stores through the enrollment function to the user terminal having enrolled the appointment information. The provider 313 may provide recommendation information as information used for the user to determine a meeting place, and may also provide affiliated store information having offered corresponding recommendation information. Here, the affiliated store information may include business type information, product/service information, contact information, such as a telephone number, location information, scale information, price information, promotion information, and the like. The provider 313 may provide separate detailed information about affiliated stores having offered the recommendation information. Also, the provider 313 may provide a call function, a chat function, a video chat function, an email function, an SMS function, etc., between the user and an affiliated store representative as a communication channel for inquiry, requirements, and the like within the messenger over the reservation.

The provision of the recommendation information may be performed, e.g., by operations 440-1 and 440-2 as follows. In operation 440-1, the provider 313 may receive recommendation information from the selected affiliated stores. In operation 440-2, the provider 313 may transmit, as the recommendation information in operation 440, the received recommendation information and/or information on the selected affiliated stores to the user terminal.

The provider 313 may provide a reservation function to the user having enrolled the appointment information. The reservation function includes a function that enables the user to request a reservation to the corresponding affiliated store having offered the recommendation information. Also, the reservation function may further include a vote function for a meeting place. If the user selects two or more candidate affiliated stores and posts a vote, users included in the number of persons associated with the meeting may participate in the vote and may determine a final meeting place. Accordingly, the provider 313 may transfer reservation request information to the affiliated store selected as the final meeting place. The reservation request information may be transferred with including recently updated appointment information.

Once the reservation associated with the appointment information of the user is confirmed, the provider 313 may notify the users included in the persons of the meeting that the meeting place is reserved and may provide reservation information about the meeting place. If time information is included in the appointment information, the provider 313 may provide a notification to the persons of the meeting based on the time information. For example, the provider 313 may transfer a message, telephone call, SMS, email, chat, and the like to the persons a desired and/or preset time, for example, one hour earlier before the time included in the appointment information.

A vote opportunity, reservation information, a notification, etc., may be provided to all of the users including absentees or may be provided only to attendees among the persons of the meeting. After the reservation is confirmed, the provider 313 may control the appointment information of the user to be displayed for the affiliated store reserved as the meeting place, and may control the appoint information not be displayed for other affiliated stores. Additionally, the provider 313 may limit enrollment of recommendation information.

Although it is described that counter offers about appointment information are received from a portion of the selected affiliated stores, it is only an example. As another example, the provider 313 may provide an environment in which affiliated stores are allowed to search for and check appointment information enrolled with respect to the entire set of affiliated stores, and to allow the entire set of affiliated stores to offer benefits, services, etc., for the respective appointment information (e.g., allow all of the affiliated stores to provide a counter offer to the initial offer from the user and/or attendees). Here, the provider 313 may not display appointment information of which a reservation is confirmed for affiliated stores and may display appointment information of which a reservation is unfixed or cancelled for affiliated stores. Additionally, the provider 313 may allow one or more of the other affiliated stores (e.g., either other selected affiliated stores and/or any of the other affiliated stores) to provide counter offers in the event that a first affiliated store and the user/attendees do not reach an agreement. Moreover, while the term “store” is used, the example embodiments are not limited thereto and the affiliated store may be a restaurant, a bar, a nightclub, a sports venue, a public space, a park, a wedding/reception venue, an office space, an amusement venue, a concert venue, an auditorium, a place of worship, a school, a hotel, a home, etc.

According to at least some example embodiments, affiliated stores may provide recommendation information as a counter offer based on appointment information enrolled by a user.

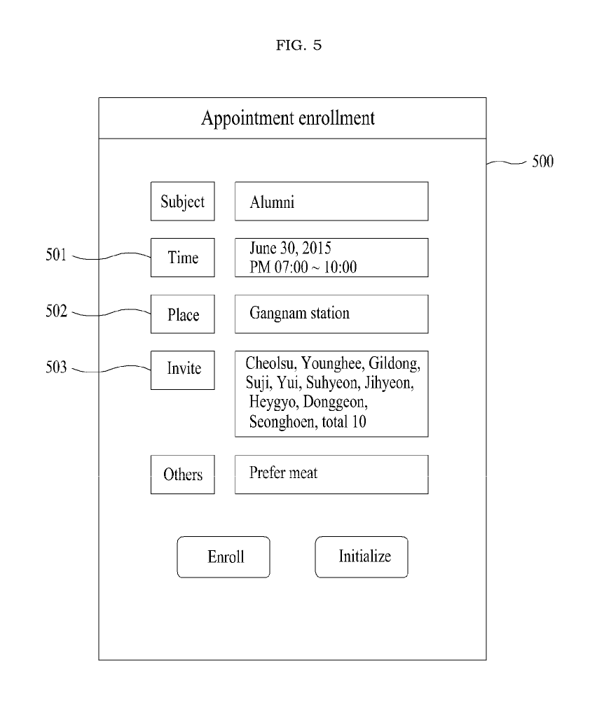

FIG. 5 illustrates an example of an appointment enrollment screen 500 displayed on a user terminal as a user interface associated with an appointment enrollment procedure according to at least one example embodiment.

The appointment enrollment screen 500 may include a time input menu 501 for inputting a meeting time, a place input menu 502 for inputting a meeting place, and a member input menu 503 for inputting the identities and/or number of persons associated with a meeting.

The time input menu 501 may include a function of calling a calendar, a schedule, etc., to select a date, the place input menu 502 may include a function of calling a map service, a search service, etc., and the member input menu 503 may include a function of calling a conversation group or a conversation party on a messenger, a contact, etc.

Also, the appointment enrollment screen 500 may further include a menu for inputting a category, such as a business type, a service, etc., (e.g., restaurant, bar, concert venue, auditorium, sports venue, wedding/reception hall, school, church, office space, park, amusement venue, etc.) with respect to an affiliated store that desires to be recommended as a meeting place.

The appointment enrollment screen 500 may further include a menu for inputting a subject, such as a meeting subject, etc., a menu for inputting other contents, such as preferences, for example, a preferred place or food, an avoiding place or food (e.g., places, goods, services, etc., that the users wish to avoid), tastes of some attendees, etc., associated with the meeting.

The enroller 311 may enroll appointment information of the user based on information input through the appointment enrollment screen 500. The provider 313 may provide the enrolled appointment information to at least a portion of the affiliated stores (e.g., one or more of the affiliated stores).

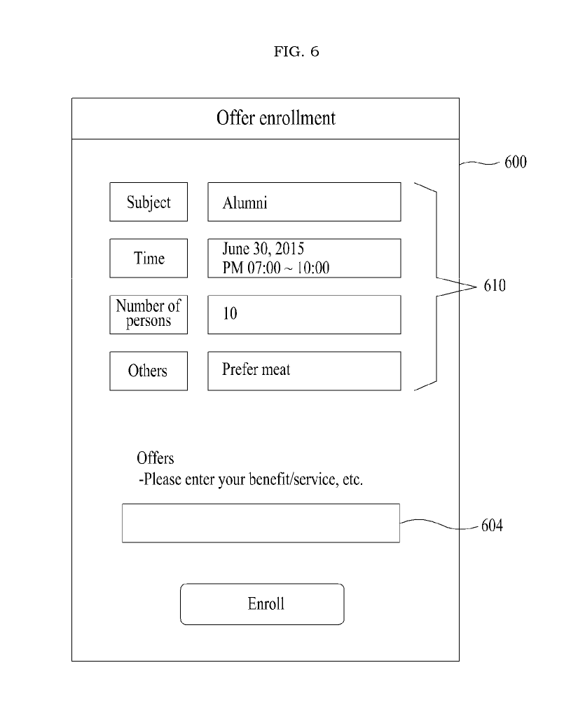

FIG. 6 illustrates an example of an offer enrollment screen 600 displayed on an affiliated store terminal as a user interface associated with a counter offer enrollment procedure of an affiliated store according to at least one example embodiment.

The offer enrollment screen 600 may display appointment information 610 enrolled by a user on a service page displayed on a terminal of an affiliated store. The offer enrollment screen 600 may include an offer input menu 604 for inputting recommendation information about at least one of a place, a product, and a service as counter offer information with respect to the appointment information 610.

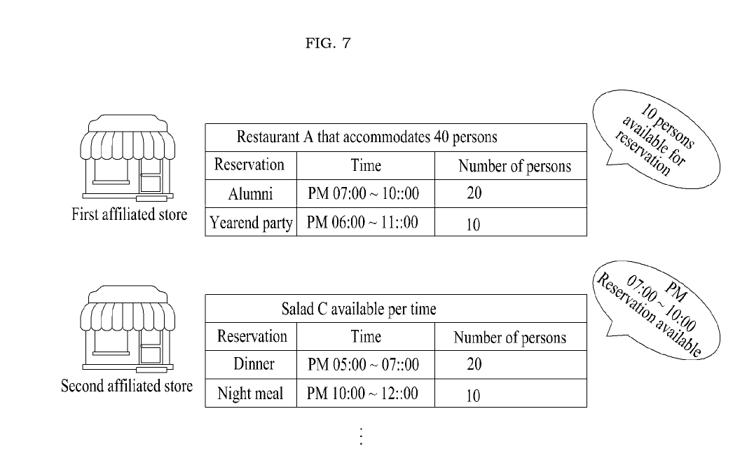

An affiliated store may verify the appointment information 610 displayed on the offer enrollment screen 600 and may make various types of counter offers for each item of the appointment information 610. Referring to FIG. 7, if a meeting time of appointment information is 7 PM to 10 PM, and the number of persons is 10, a first affiliated store having a room for ten persons and a second affiliated store available between 7 PM and 10 PM may make a counter offer with respect to the appointment information. As described above, a popular affiliated store may enroll the number of persons, a time, etc., available for a reservation through a counter offer benefit.

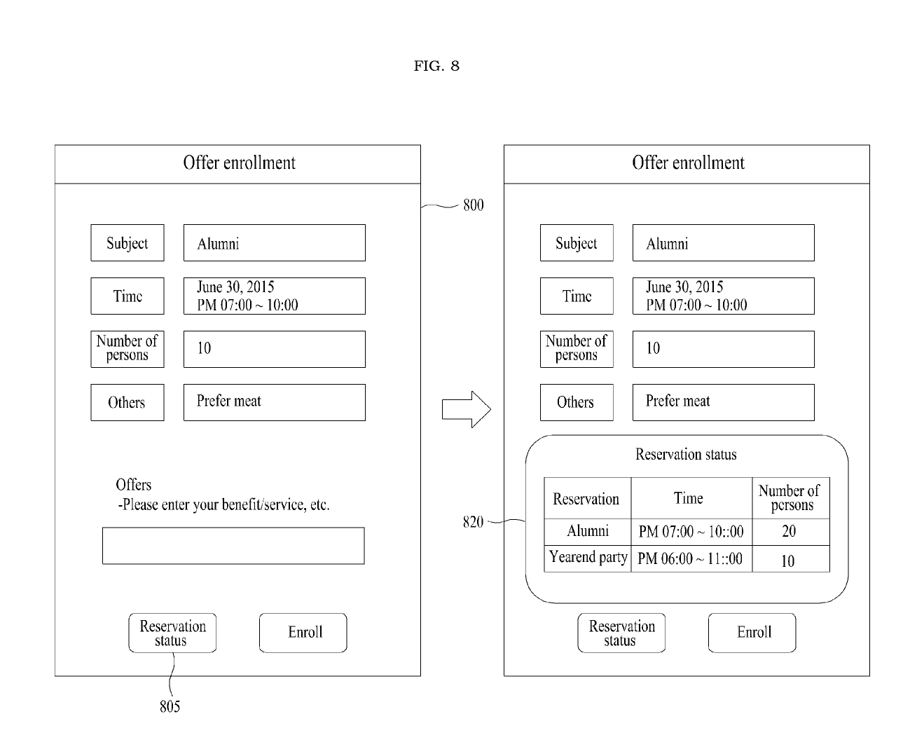

Further, referring to FIG. 8, an offer enrollment screen 800 may include a reservation management function capable of managing a reservation status of an affiliated store through a calendar, a schedule, etc., a reservation status menu 805 for calling a reservation status, etc. In response to selecting the reservation status menu 805, a popup screen 820 including a reservation status of the affiliated store may appear. The affiliated store may initially verify a reservation status using the reservation management function before enrolling an offer and then determine whether a counter offer is available.

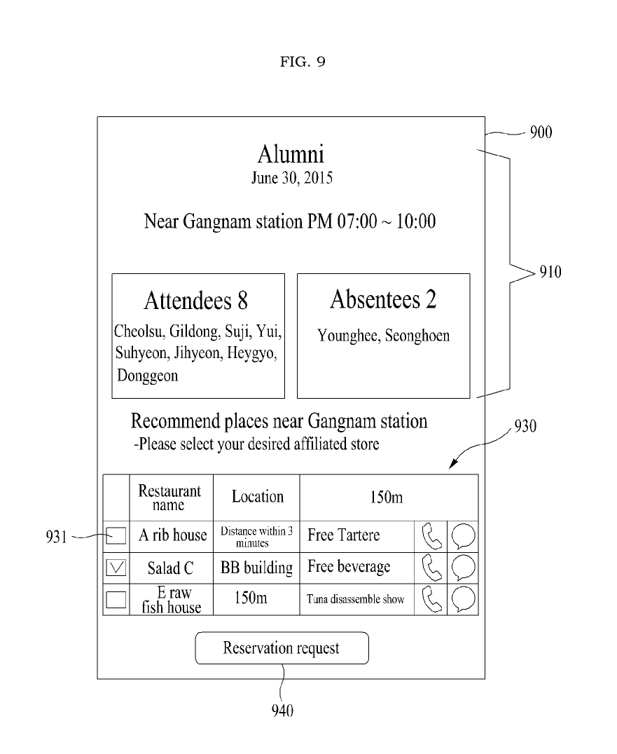

FIG. 9 illustrates an example of an appointment verification screen 900 displayed on a user terminal as a user interface associated with a place reservation procedure according to at least one example embodiment.

The appointment verification screen 900 may display appointment information 910 of a corresponding meeting on a service page displayed on terminals of users associated with persons of the meeting, and may include a menu for enrolling a user intention to attend or not to attend. Depending on cases, the persons of the meeting may be classified into attendees and absentees and thereby be displayed on the appointment verification screen 900.

In particular, an affiliated store list 930 of affiliated stores having enrolled a counter offer with respect to appointment information 910 may be displayed on the appointment verification screen 900. Here, the affiliated store list 930 may include a name, a distance from a meeting place, a location, a type of business, etc., of an affiliated store, and may include a benefit, a service, a promotion, etc., offered at the affiliated store.

The affiliated store list 930 may include a place selection menu 931 that enables a user to select a meeting place. Further, the affiliated store list 930 may further include a communication function such as a call connection, a real-time chat, a homepage link, etc., as a menu for directly contacting with an affiliated store, supporting a service connection, etc.

The appointment verification screen 900 may include a reservation request menu 940 for requesting a reservation to an affiliated store selected by the user as a final meeting place from the affiliated store list 930.

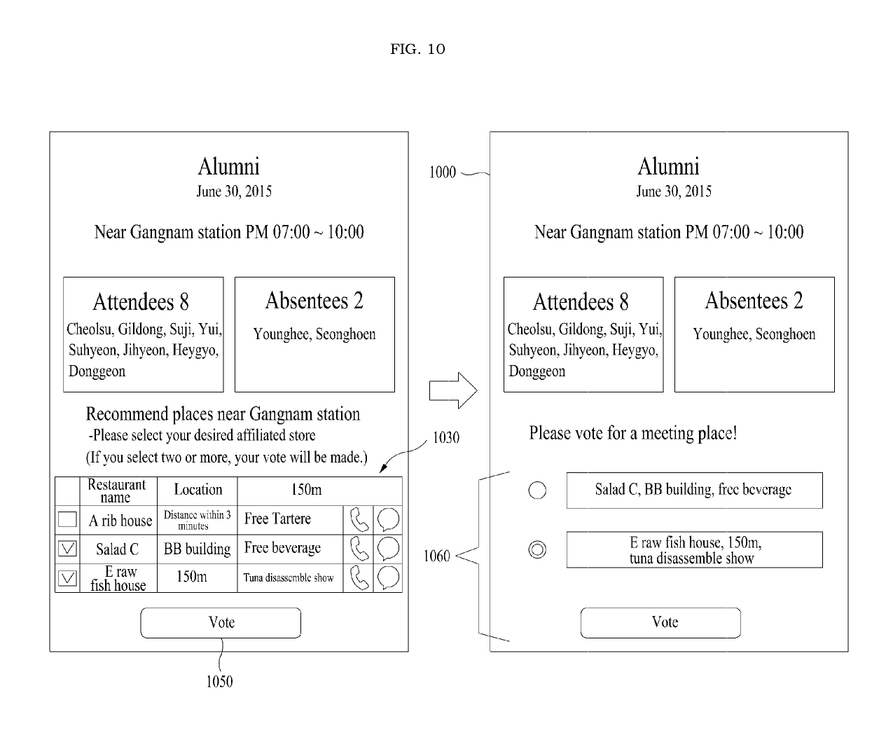

As another example, an appointment verification screen may include a vote function for a meeting place. Referring to FIG. 10, an appointment verification screen 1000 may include a vote menu 1050 that enables a user to select two or more candidate affiliated stores from an affiliated store list 1030 and to vote for. Once a vote is made, the appointment verification screen 1000 may include a vote participation menu 1060 that enables a user to select one of the candidate affiliated stores.

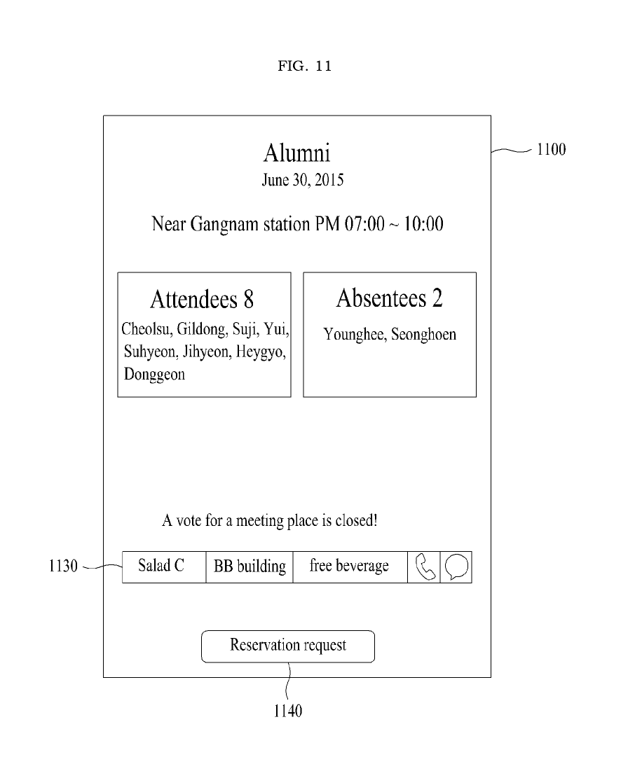

Referring to FIG. 11, once a vote is closed, information 1130 about an affiliated store selected through the vote may be displayed on an appointment verification screen 1100. The appointment verification screen 1100 may include a reservation request menu 1140 for requesting the selected affiliated store for a reservation as a meeting place.

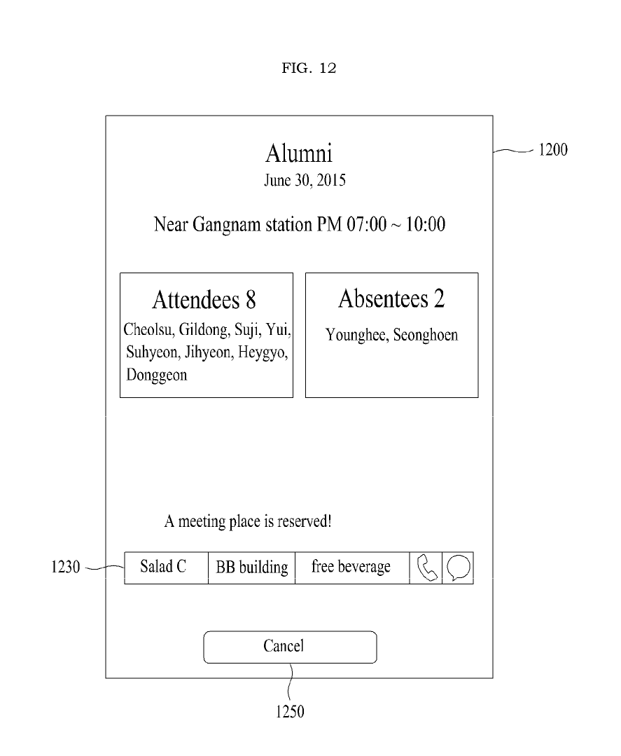

Referring to FIG. 12, once a reservation at a meeting place is completed, information 1230 about an affiliated store of which a reservation is confirmed as the meeting place may be displayed on an appointment verification screen 1200. Further, the appointment verification screen 1200 may include a reservation cancellation menu 1250 for requesting the reserved affiliated store to cancel the reservation due to a meeting cancellation, a change of the meeting place, etc.

During the above process, a right to request a reservation, a right to vote, a right to cancel a reservation, etc., may be granted to a user having created appointment information and/or one or more of the attendees of the meeting.

The meeting place recommendation method may include a reduced number of operations or additional operations based on the detailed description made above with reference to FIGS. 1 through 12. Also, two or more operations may be combined and order or locations of operations may be changed.

FIGS. 5 through 12 illustrate examples of screens provided to help understanding of the present disclosure and simplicity of description. Thus, a configuration, order, and the like of each screen may be modified.

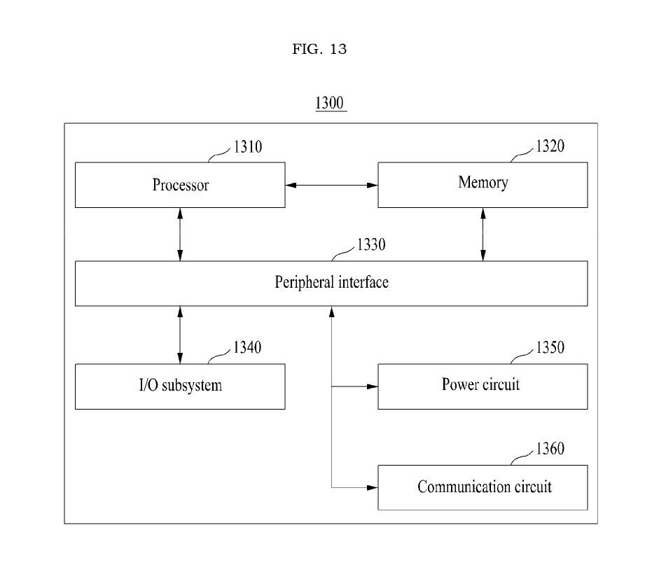

FIG. 13 is a block diagram illustrating an example configuration of a computer system according to at least one example embodiment. Referring to FIG. 13, a computer system 1300 includes at least one processor 1310; a memory 1320; a peripheral interface 1330; an input/output (I/O) subsystem 1340; a power circuit 1350; and a communication circuit 1360. The computer system 1300 may correspond to a user terminal, and/or an affiliated store terminal.

The memory 1320 may include, for example, a high-speed random access memory (HSRAM), a magnetic disk, a static random access memory (SRAM), a dynamic RAM (DRAM), read only memory (ROM), a flash memory, a non-volatile memory, etc. The memory 1320 may include a software module, an instruction set, or a variety of data required for operation of the computer system 1300. Here, access from another component, such as the processor 1310 and the peripheral interface 1330, to the memory 1320 may be controlled by the processor 1310.

The peripheral interface 1330 may couple an input device and/or output device of the computer system 1300 with the processor 1310 and the memory 1320. The processor 1310 may perform a variety of functions for the computer system 1300 and process data by executing the software module and/or the instruction set stored in the memory 1320.

The I/O subsystem 1340 may couple various I/O peripheral devices with the peripheral interface 1330. For example, the I/O subsystem 1340 may include a controller for coupling the peripheral interface 1330 and a peripheral device, such as a monitor, a keyboard, a mouse, a printer, a touch screen and/or a sensor depending on a necessity. The I/O peripheral devices may be coupled with the peripheral interface 1330 without using the I/O subsystem 1340.

The power circuit 1350 may supply power to all, or a portion, of components of a terminal. For example, the power circuit 1350 may include a power management system, at least one power source such as a battery and alternating current (AC) circuit, a charge system, a power failure detection circuit, a power converter or inverter, a power status indicator, and/or other components for creating, managing and/or distributing power.

The communication circuit 1360 enables communication with another computer system using at least one external port. Additionally, as described above, the communication circuit 1360 may enable communication with another computer system by including a radio frequency (RF) circuit, and thereby transmitting and receiving an RF signal known as an electromagnetic signal.

The example embodiment of FIG. 13 is only an example of the computer system 1300. The computer system 1300 may have a configuration and/or an arrangement in which a portion of the components illustrated in FIG. 13 is/are omitted, further components not illustrated in FIG. 13 are included, or two or more components are coupled together. For example, a computer system for a communication terminal of a mobile environment may further include a touch screen, a sensor, and the like, in addition to the components of FIG. 13. A circuit for RF communication using a variety of communication methods, for example, wireless fidelity (Wi-Fi), 3rd generation (3G), 4th generation (4G), 5th generation (5G) long term evolution (LTE), Bluetooth, near field communication (NFC), and ZigBee, may be included in the communication circuit 1360. Components that may be included in the computer system 1300 may be configured as hardware that includes one or more integrated circuits specified for at least one signal processing or application, software, or a combination of hardware and software.

According to at least some example embodiments, it is possible to effectively connect a purchase and a service between a user and an affiliated store by providing appointment information of a meeting associated with users to affiliated stores, and by receiving recommendation information about a meeting place from the affiliated stores as a counter offer and providing the received recommendation information to the users. Accordingly, it is possible to reduce, or alternatively, minimize inconvenience and cumbersomeness of the users taken to find a meeting place by running through appointment information. Further, since users may immediately proceed with a reservation procedure in response to a counter offer from an affiliated store, the users may further easily and conveniently determine the meeting place. Also, an affiliated store may achieve shop/store promotion and customer attraction through an online to offline (O2O) marketing opportunity by providing recommendation information with respect to appointment information of users.

According to at least some example embodiments, by operations of the meeting place recommendation system 100, specifically by providing user's appointment information to the selected affiliated stores, acquiring the recommendation information from the selected affiliated stores and providing it to the user terminal, it is possible to handle the processes, such as a reservation process, without excessive searching operations in the user terminal or troublesomely contacting with the affiliated stores. It results in reducing the amount of usage of unnecessary hardware and/or software resources in the user terminal and improving the performance thereof.

The methods according to at least some example embodiment may be configured as program instructions executable through a variety of computer systems and recorded in non-transitory computer-readable media.

A program according to the example embodiments may be configured as a PC-based program or an application exclusive for a mobile terminal. An app associated with a messenger service according to at least some example embodiments may be configured in an independently operating program form or an in-app form of a specific application to be operable on the specific application.

Also, the methods according to at least one some example embodiments may be performed in such a manner that an application associated with a server system that provides a messenger service controls a user terminal. For example, the application may execute one or more processes configured to perform one of the features described herein. The application may be installed in the user terminal through a file provided from a file distribution system. For example, the file distribution system may include a file transmitter (not shown) to transmit the file in response to a request from the user terminal.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method executed by at least one processor, the method comprising:
enrolling, using at least one processor, appointment information based on information received from at least one user terminal over a network;
selecting, using the at least one processor, at least one affiliated store from a plurality of affiliated stores based on location information, the location information including the enrolled appointment information;
transmitting, using the at least one processor, the appointment information to the selected at least one affiliated store over the network, and enrolling at least one counter offer associated with the appointment information from at least one of the plurality of affiliated stores, the enrollment including enabling the plurality of affiliated stores to input and enroll recommendation information about at least one of a place, a product, and a service in association with the appointment information; and
transmitting, using the at least one processor, the enrolled recommendation information to the at least one user terminal.

2. The method of claim 1, further comprising:
transmitting, using the at least one processor, a reservation request for a meeting place to an affiliated store having enrolled the recommendation information in response to a request from the user terminal.

3. The method of claim 1, wherein the transmitting of the recommendation information includes transmitting a list of affiliated stores having enrolled the recommendation information to the user terminal, and
the method further comprises:
receiving, using the at least one processor, a selection on a desired affiliated store from the list of affiliated stores from the user terminal; and
transmitting, using the at least one processor, a reservation request for a meeting place to the desired affiliated store in response to receiving the selection.

4. The method of claim 3, further comprising:
receiving, using the at least one processor, a selection on a plurality of affiliated stores from the list of affiliated stores from the user terminal;
enrolling, using the at least one processor, a vote for the plurality of affiliated stores based on the appointment information in response to receiving the selection on the plurality of affiliated stores;
receiving, using the at least one processor, a vote intention for one of the plurality of affiliated stores from a terminal of each of persons associated with the appointment information; and
selecting, using the at least one processor, the desired affiliated store from among the plurality of affiliated stores based on the vote intention.

5. The method of claim 3, wherein the transmitting of the recommendation information includes transmitting a corresponding affiliated store within a messenger application with respect to each of the affiliated stores included in the list of affiliated stores.

6. The method of claim 2, further comprising:
transmitting, using the at least one processor, reservation information to at least one terminal of each of persons associated with the appointment information if a reservation for the meeting place is completed.

7. The method of claim 1, further comprising:
transmitting, using the at least one processor, an alert of the appointment information to at least one terminal of each of persons associated with the appointment information based on time information included in the enrolled appointment information.

8. The method of claim 1, wherein the enrolling includes enrolling appointment information created through a messenger application.

9. The method of claim 1, wherein the enrolling includes managing a reservation status of an affiliated store in association with a messenger application.

10. The method of claim 1, wherein the enrolling includes updating the appointment information based on attendance or absence of each of persons associated with the appointment information.

11. A non-transitory computer-readable medium comprising computer readable instructions, which when executed by at least one processor, causes the at least one processor to:
enroll appointment information based on information received from at least one user terminal over a network;
select affiliated stores based on location information including the enrolled appointment information;
transmit the appointment information to the selected affiliated stores, and enrolling a counter offer associated with the appointment information to the affiliated stores, the enrolling including enabling the affiliated stores to input and enroll recommendation information about at least one of a place, a product, and a service in association with the appointment information; and
transmit the recommendation information enrolled through the user terminal.

12. A system for recommendation a meeting place, the system comprising:
a memory having computer readable instructions stored thereon; and
at least one processor configured to execute the computer readable instructions to,
enroll appointment information based on information received from at least one user terminal over a network;
select affiliated stores based on location information including the enrolled appointment information; and
transmit the appointment information to the selected affiliated stores, and enrolling a counter offer associated with the appointment information to the affiliated stores and transmit the enrolled recommendation information to the at least one user terminal, the enrolling including enabling the affiliated stores to input and enroll recommendation information about at least one of a place, a product, and a service in association with the appointment information.

13. The system of claim 12, wherein the at least one processor is further configured to transmit a reservation request for a meeting place to an affiliated store having enrolled the recommendation information in response to a request from the at least one user terminal.

14. The system of claim 12, wherein the at least one processor is further configured to:
transmit a list of affiliated stores having enrolled the recommendation information to the at least one user terminal; and
transmit a reservation request for a meeting place to a desired affiliated store in response to receiving a selection on the desired affiliated store from the list of affiliated stores from the at least one user terminal.

15. The system of claim 14, wherein, in response to receiving a selection on a plurality of affiliated stores from the list of affiliated stores from the at least one user terminal, the at least one processor is further configured to:
enroll a vote for the plurality of affiliated stores based on the appointment information;
receive a vote intention for one of the plurality of affiliated stores from at least one terminal of each of persons associated with the appointment information; and
select the desired affiliated store from among the plurality of affiliated stores based on the vote intention.

16. The system of claim 14, wherein the at least one processor is further configured to transmit to a corresponding affiliated store within a messenger application with respect to each of the affiliated stores included in the list of affiliated stores.

17. The system of claim 13, wherein the at least one processor is further configured to transmit reservation information to at least one terminal of each of persons associated with the appointment information if a reservation for the meeting place is completed.

18. The system of claim 12, wherein the at least one processor is further configured to transmit an alert of the appointment information to at least one terminal of each of persons associated with the appointment information based on time information included in the enrolled appointment information.

19. The system of claim 12, wherein the at least one processor is further configured to enroll appointment information created through a messenger application.

20. The system of claim 12, wherein the enrolling includes managing a reservation status of an affiliated store in association with a messenger application.
